(19) United States
(12) Patent Application Publication
(10) Pub. No.: US 2018/0155842 A1
(43) Pub. Date: Jun. 7, 2018

(54) MOISTURE ELECTROLYSIS APPARATUS FOR HEADLAMP

(71) Applicant: Hyundai Motor Company, Seoul (KR)

(72) Inventors: Sang Shin LEE, Suwon-si (KR); Jae Woo PARK, Ansan-si (KR); So Yoon PARK, Suwon-si (KR); Man Ju OH, Yongin-si (KR); Jae Woong KIM, Hwaseong-si (KR); So La CHUNG, Seoul (KR)

(73) Assignee: Hyundai Motor Company, Seoul (KR)

(21) Appl. No.: 15/372,283

(22) Filed: Dec. 7, 2016

(51) Int. Cl. C25B 1/06; C25B 9/06; C25B 11/03; B60Q 1/04; F21S 8/10

(52) U.S. Cl. CPC C25B 1/06; C25B 9/06; F21S 48/335; B60Q 1/04; C25B 11/03

(57) ABSTRACT

Disclosed herein is a moisture electrolysis apparatus for a headlamp including: a first electrode configured to be exposed in an inside space of a headlamp housing, and have a surface coated with a dielectric substance; a second electrode configured to be disposed to be spaced apart from the first electrode by a predetermined distance; and a discharge ventilation path configured to be formed between the surface of the first electrode coated with the dielectric substance and the second electrode.

### CROSS REFERENCE TO RELATED APPLICATION

The present application claims priority to Korean Patent Application No. 10-2016-0116232, filed on Sep. 9, 2016, the entire contents of which is incorporated herein for all purposes by this reference.

### BACKGROUND OF THE INVENTION

### Field of the Invention

The present invention relates to an apparatus for fundamentally removing moisture formed inside a headlamp by electrolysis.

### Description of Related Art

Generally, as a head lamp of a vehicle generates heat when a light source inside the head lamp emits light, an inside of the headlamp is heated at high temperature. The moisture inside the headlamp easily reaches a freezing point and a drop of water is formed on an inner surface of a lens, due to a temperature difference between an outer surface of the headlamp cooled by an effect of traveling wind or surrounding environment and a heated inside of the headlamp. If the drop of water is formed inside the lens and flows, parts around the lens are corroded and damaged or if the drop of water is repeatedly condensed and evaporated, a surface of the lens is scratched and the lens clouds, such that illuminance of the headlamp may be reduced.

To solve the above problem, conventionally, a method for installing a fan, or the like in a headlamp to forcibly circulate air therein or making an inner space of the headlamp a vacuum state and sealing the headlamp has been used. However, separate energy may be consumed to drive the fan, costs may be increased to make the inside of the headlamp into a vacuum state, and a set of the headlamp is replaced even when only the light source needs to be replaced to greatly increase the costs of repairing.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an apparatus for solving a problem of moisture condensation inside a headlamp and preventing performance of the headlamp from being reduced, by electrolyzing moisture inside a housing of the headlamp to remove the moisture.

According to an exemplary embodiment of the present invention, there is provided a moisture electrolysis apparatus for a headlamp including: a first electrode configured to be connected to one electrode of a power supply, exposed in an inside space of a headlamp housing, and have a surface coated with a dielectric substance; a second electrode configured to be connected to the other electrode of the power supply, exposed in the inside space of the headlamp housing, and disposed to form a gap while being spaced apart from the first electrode by a predetermined distance; and a discharge ventilation path configured to be formed between the surface of the first electrode coated with the dielectric substance and the second electrode, have air in the headlamp circulated therein, and electrolyze moisture in the air by a discharge phenomenon generated between the first electrode and the second electrode.

The first electrode and the second electrode may have a flat shape and may be disposed to face each other in parallel.

The first electrode and the second electrode may be each formed with a plurality of ventilation holes.

The ventilation holes of the first electrode and the second electrode may be formed to cross each other.

The power supply may be a DC power supply.

The first electrode may be a negative electrode.

The first electrode and the second electrode may be disposed to penetrate through a dust cover to be exposed in the inside space of the headlamp housing.

The dielectric substance may be ionomer.

The dielectric substance may be formed by impregnating ionomer in a poly tetra fluoro ethylene (PTFE) layer.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram schematically illustrating a configuration of a moisture electrolysis apparatus for a headlamp according to an exemplary embodiment of the present invention.

FIG. 2 and FIG. 3 are diagrams illustrating an electrode and a dielectric substance of the moisture electrolysis apparatus for a headlamp according to the exemplary embodiment of the present invention.

FIG. 4 is a diagram illustrating a dust cover of the moisture electrolysis apparatus for a headlamp according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, exemplary embodiments of the present invention will be described with reference to the accompanying drawings.

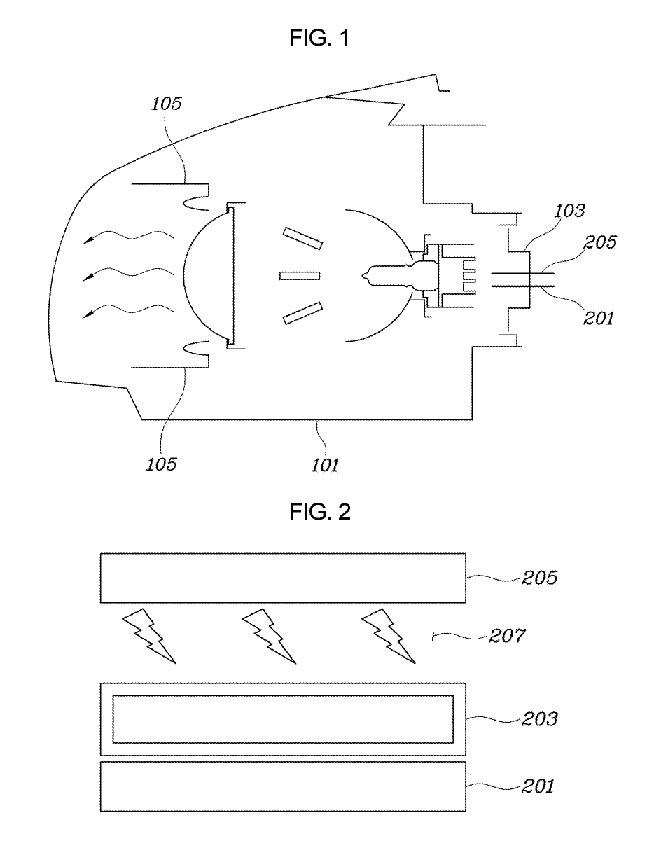

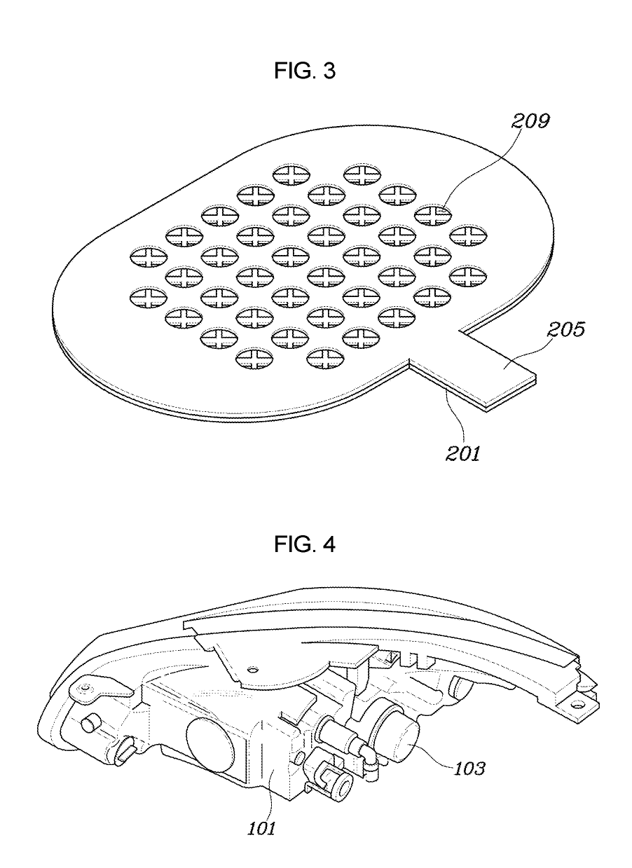

FIG. 1 is a diagram schematically illustrating a configuration of a moisture electrolysis apparatus for a headlamp according to an exemplary embodiment of the present invention and FIG. 2 and FIG. 3 are diagrams illustrating an electrode and a dielectric substance 203 of the moisture electrolysis apparatus for a headlamp according to the exemplary embodiment of the present invention, and FIG. 4 is a diagram illustrating a dust cover of the moisture electrolysis apparatus for a headlamp according to the exemplary embodiment of the present invention.

A moisture electrolysis apparatus for a headlamp according to an exemplary embodiment of the present invention includes a first electrode 201 configured to be connected to one electrode of a power supply, exposed in an inside space of a headlamp housing 101, and have a surface coated with a dielectric substance 203; a second electrode 205 configured to be connected to the other electrode of the power supply, exposed in the inside space of the headlamp housing 101, and disposed to form a gap while being spaced apart from the first electrode 201 by a predetermined distance; and a discharge ventilation path 207 configured to be formed between the surface of the first electrode 201 coated with the dielectric substance 203 and the second electrode 205, have air in the headlamp circulated therein, and electrolyze moisture in the air by a discharge phenomenon generated between the first electrode 201 and the second electrode 205. The first electrode 201 and the second electrode 205 may have a flat shape and may be disposed to face each other in parallel.

When a vehicle is driven at night, a driver's view is secured by using light from the headlamp. An inside of the headlamp is heated by heat generation of a light source while the headlamp is operated and thus the headlamp is maintained at high temperature, and therefore even though moisture is in the headlamp, the inside of the headlamp is maintained in a gas state, such that moisture is not formed on a surface of the inside of the headlamp. However, when the headlamp is turned off, an energy source to maintain the moisture inside the headlamp in the gas state disappears, while an outside of the headlamp is in a low temperature state by heat exchange with atmosphere, and therefore moisture starts to be condensed on an inside surface of the headlamp.

Alternatively, when the vehicle is parked in the open air which is directly exposed by sunlight, the temperature of the inside space of the headlamp is gradually increased by a greenhouse effect and thus moisture presented at a place which is not seen inside the headlamp is evaporated, such that the moisture is uniformly diffused to the inside of the headlamp. On the other hand, the outside of the headlamp is maintained at a lower temperature than that of the inside of the headlamp due to the heat exchange with the atmosphere, and therefore the diffused moisture is condensed on the surface of the inside of the headlamp, such that moisture may be generated.

At this point, when the condensed drop of water is formed inside the headlamp and flows, relevant parts around the headlamp are corroded and thus may be damaged, and when the drop of water is repeatedly condensed and evaporated, the inside surface of the lens of the headlamp is scratched and the lens clouds, such that illuminance of the headlamp may be reduced.

To solve the problem, there is a need to keep the humidity of the inside of the headlamp low. To this end, a method for assembling a headlamp in a completely dehumidified space to block an introduction of moisture from the beginning may be applied. However, moisture may always be introduced under the situation that a bulb needs to be exchanged later or the headlamp needs to be repaired. Therefore, there is a need to lower humidity inside the headlamp later.

There are two methods for lowering humidity in the air. One is a method for lowering relative humidity by increasing a temperature of air and the other is a method for lowering absolute humidity by removing moisture in the air. The method for lowering relative humidity may not be a fundamental method because moisture is again condensed inside the headlamp when the temperature inside the headlamp drops. Therefore, the present invention is to remove moisture inside the headlamp by electrolyzing the moisture.

Generally, water is electrolyzed by plugging an electrode in water including an electrolyte. However, in the case of the headlamp, the amount of moisture is insufficient and therefore electricity does not flow, such that the typical electrolysis method may not be applied to the headlamp.

Accordingly, the present invention is to electrolyze moisture in the air by inducing a discharge in a low voltage.

Referring to FIG. 1 and FIG. 2, a first electrode 210 is connected to one electrode of a power supply and exposed in an inside space of a headlamp housing 101 and a second electrode 205 is disposed to be spaced apart from the first electrode 201 by a predetermined distance. Basically, a current flows along a connected electric wire, but when a very high voltage is applied even in the state in which the electric wire is disconnected, electrons directly jump between the disconnected electric wire and thus a current flows, such that a discharge may be generated. However, it is difficult to secure a high voltage as much as inducing a direct discharge in a vehicle and it is not preferable to generate a discharge in a high voltage in a vehicle including a plurality of electronic components. Therefore, there is a need to generate a discharge in a low voltage.

A dielectric substance 203 coated on the first electrode 201 serves to generate the discharge in the low voltage. The dielectric substance 203 is coated on a surface of the electrode to uniformly generate a discharge over the whole surface of the electrode and facilitate an emission of electron, serving to induce a generation of a discharge even in the low voltage.

A gap is formed between the surface of the first electrode 201 coated with the dielectric substance 203 and the second electrode 205 to form a discharge ventilation path 207 through which air in the headlamp may pass. A discharge is generated in the discharge ventilation path 207 and moisture included in the headlamp is electrolyzed while air in the headlamp passes through the space. By this, absolute humidity of air in the headlamp may be lowered.

The first electrode 201 and the second electrode 205 may each be formed with a plurality of ventilation holes 209. The ventilation holes 209 of the first electrode 201 and the second electrode 205 may be formed to cross each other.

The discharge ventilation path 207 formed between the first electrode 201 and the second electrode 205 has a very narrow interval. When the interval between the electrodes is wide, the amount of air corresponding to an insulator is increased and thus a resistance is increased, such that it is difficult to generate the discharge in the low voltage. Therefore, the interval is formed to be a narrow interval of several mm or less. In the instant case, the air in the headlamp may not be smoothly supplied to the discharge ventilation path 207.

Accordingly, according to the exemplary embodiment of the present invention, as illustrated in FIG. 3, the electrode itself is formed with the ventilation hole 209 to smoothly supply air to the discharge ventilation path 207. Further, the ventilation holes 209 formed in the first electrode 201 and the second electrode 205 are not formed to be aligned to each other but to cross each other to increase time for which air introduced through the ventilation holes 209 stays in the discharge ventilation path 207, providing a sufficient time to decompose moisture in the air.

According to the exemplary embodiment of the present invention, as a power supply, a DC power supply is used.

When the DC power supply is used, a high voltage is required to generate a flow of current between electrodes that are not connected to each other. However, this may cause an excessive loss of energy and cause a damage of peripheral components, and therefore a low-voltage discharge using an AC current has been used in industries.

However, a battery, etc., used in a vehicle is a DC power supply but may have a problem in that it does not generate a high voltage to smoothly generate a discharge. Of course, the problem may be solved by changing the DC power supply to an AC power supply using additional apparatuses including an inverter, which increases costs and requires a disposition space of separate components and thus is inefficient.

Therefore, according to the exemplary embodiment of the present invention, the first electrode 201 is coated with the dielectric substance 203 to generate the discharge in the low voltage while using the DC power supply.

According to the exemplary embodiment of the present invention, the first electrode 201 coated with the dielectric substance 203 is set to be a negative electrode.

The dielectric substance 203 uses ionomer to be described below in detail. The ionomer helps a movement of electron using an electrostatic force to serve to help the discharge in the low voltage. The negative electrode at which electron is present is coated with the dielectric substance to directly help the movement of electron, inducing the smooth generation of the discharge in the low voltage.

The first electrode 201 and the second electrode 205 are mounted to penetrate through a dust cover 103 and thus may be exposed in the inside space of the headlamp housing 101.

The first electrode 201 and the second electrode 205 need to be ultimately exposed in the inside of the headlamp housing 101 and attaching the first electrode 201 and the second electrode 205 to an inside surface of the headlamp at which a condensation of moisture is generated most frequently may be most efficient. However, this may cause a problem of screening light of the headlamp and spoiling an appearance due to the exposure to the outside.

Therefore, the first electrode 201 and the second electrode 205 are attached to a back surface, etc., of a bezel 105 at the top or the bottom of the headlamp housing 101 that is not directly observed from the outside of the headlamp housing 101 and thus may be mounted at a hidden portion after the assembly of components.

Alternatively, as illustrated in FIG. 4, the first electrode 201 and the second electrode 205 may be mounted on the dust cover 103 that is mainly used to replace a bulb within the headlamp later. By doing so, the present invention may be applied to all car models only by replacing the dust cover 103 independent of car models and thus may achieve the publication of parts to save manufacturing costs.

The dielectric substance 203 is ionomer.

The dielectric substance 203 needs to serve to help the movement of electron to efficiently generate the discharge even in the low voltage.

The ionomer is a polymer material including a positive charge or a negative charge. In more detail, the ionomer is a thermoplastic plastic material having both a covalent bond and an ion bond and has a very excellent electrostatic force. Basically, the ionomer is the plastic polymer material and has a nature of the dielectric substance 203 and the insulator, but helps the movement of electron using the excellent electrostatic force to help the discharge in the low voltage.

The dielectric substance 203 may be formed by impregnating the ionomer into a poly tetra fluoro ethylene (PTFE) layer.

The foregoing dielectric substance 230 essentially has durability to maintain performance even when it is exposed to various changes in temperature and humidity, vibration, etc., for a long time period in that it is mounted inside the headlamp of the vehicle.

Therefore, according to the exemplary embodiment of the present invention, the electrode is coated with the ionomer that is impregnated into the PTFE, that is, porous Teflon layer that is not easily peeled off even at the time of plating without the change in chemical properties at high temperature (300° C. or more). By doing so, it is possible to improve the durability of the coating of the dielectric substance 203 while maintaining the excellent electrostatic force of the ionomer.

As described above, according to the moisture electrolysis apparatus for a headlamp of the present invention, it is possible to prevent the performance of the headlamp from being reduced by removing the moisture condensed inside the headlamp and prevent the condensation problem of moisture from occurring even though the high-humidity air is introduced while the bulb of the headlamp is replaced or the headlamp is repaired.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “interior”, “exterior”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A moisture electrolysis apparatus for a headlamp, comprising:
a first electrode configured to be connected to one electrode of a power supply, exposed in an inside space of a headlamp housing, and have a surface coated with a dielectric substance;
a second electrode configured to be connected to another electrode of the power supply, exposed in the inside space of the headlamp housing, and disposed to form a gap while being spaced apart from the first electrode by a predetermined distance; and
a discharge ventilation path configured to be formed between a surface of the first electrode coated with the dielectric substance and the second electrode, have air in the headlamp circulated therein, and electrolyze moisture in the air by a discharge phenomenon generated between the first electrode and the second electrode.

2. The moisture electrolysis apparatus for the headlamp of claim 1, wherein the first electrode and the second electrode have a flat shape and are disposed to face each other in parallel.

3. The moisture electrolysis apparatus for the headlamp of claim 2, wherein the first electrode and the second electrode are each formed with a plurality of ventilation openings.

4. The moisture electrolysis apparatus for the headlamp of claim 3, wherein the ventilation openings of the first electrode and the second electrode are formed to cross each other.

5. The moisture electrolysis apparatus for the headlamp of claim 1, wherein the power supply is a DC power supply.

6. The moisture electrolysis apparatus for the headlamp of claim 1, wherein the first electrode is a negative electrode.

7. The moisture electrolysis apparatus for the headlamp of claim 1, wherein the first electrode and the second electrode are disposed to penetrate through a dust cover to be exposed in the inside space of the headlamp housing.

8. The moisture electrolysis apparatus for the headlamp of claim 1, wherein the dielectric substance is ionomer.

9. The moisture electrolysis apparatus for the headlamp of claim 1, wherein the dielectric substance is formed by impregnating ionomer in a poly tetra fluoro ethylene (PTFE) layer.
